(19) United States
(12) Patent Application Publication
(10) Pub. No.: US 2009/0164811 A1
(43) Pub. Date: Jun. 25, 2009

(54) Methods For Analyzing Environmental Data In An Infrastructure

(76) Inventors: Ratnesh Sharma, Fremont, CA (US); Chih Ching Shih, San Jose, CA (US); Chandrakant Patel, Fremont, CA (US); John Sontag, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/263,432

(22) Filed: Oct. 31, 2008

Related U.S. Application Data
(60) Provisional application No. 61/016,072, filed on Dec. 21, 2007.

(51) Int. Cl. G06F 1/00; G06G 7/12; G06F 15/18; G01K 3/14; G06Q 99/00; G06F 7/38; G06F 17/14

(52) U.S. Cl. 713/310; 708/806; 706/21; 708/445; 708/403; 374/137; 705/1

(57) ABSTRACT

Embodiments include methods, apparatus, and systems for analyzing data in an infrastructure. One embodiment includes a method that senses environmental data at equipment racks in an infrastructure, identifies patterns in the environmental data, and uses the patterns to modify the infrastructure to improve thermal management in the infrastructure.

### CROSS-REFERENCE TO RELATED APPLICATION

The present application claims priority from provisional application Ser. No. 61/016,072, filed Dec. 21, 2007, the contents of which are incorporated herein by reference in their entirety.

### BACKGROUND

Rise in demand for computing has driven the emergence of high density datacenters. With the advent of high density, mission-critical datacenters, demand for electrical power for compute and cooling has grown. Deployment of a large number of high powered computer systems in very dense configurations in racks within data centers results in very high power densities and temperatures. Hosting business and mission-critical applications also demands a high degree of reliability and flexibility. Managing such high power levels in the data center with cost effective reliable cooling solutions is needed to maintain a feasible compute infrastructure.

Thermal management in datacenters is also becoming more complex due to increases in rack level power density resulting from system level compaction and energy demands. Energy consumption in data centers has been significantly increased by over-designed air handling systems and rack layouts that allow the hot and cold air streams to mix.

### BRIEF DESCRIPTION OF THE DRAWINGS

FIG. 1 is a datacenter in accordance with an exemplary embodiment.

FIG. 2 is a server rack in accordance with an exemplary embodiment.

FIG. 3 is a flow diagram for collecting and analyzing data in a datacenter in accordance with an exemplary embodiment.

FIG. 4 is a block diagram of a computer for executing methods in accordance with an exemplary embodiment.

### DETAILED DESCRIPTION

Embodiments are directed to apparatus, systems, and methods to collect environmental conditions in a datacenter and then analyze collected information to optimize the infrastructure of the datacenter and predict or prevent the occurrence of future events effecting operations in the datacenter.

In one embodiment, environmental data is collected in a facility or infrastructure, such as a datacenter, and used to understand the mechanisms of cooling the datacenter. Sensors are placed in the datacenter (for example, at inlets and outlets of equipment or server racks) to collect streaming environmental data. A determination is made as to whether a distribution of the data is random or systemic. Systemic data is further analyzed for the occurrence of patterns. By way of example, the collected data can include one or more patterns associated with space (for example, a specific location of a sensor), time (for example, time of day, month, seasonal, etc. when data is collected), or utilization (for example, data collected during a power surge). Autocorrelations are then applied to understand traits in the collected environmental data.

Results of the analysis on the collected environmental data are used to optimize or build a datacenter or other facility housing electronic equipment and/or computers. By way of example, the analysis is used to change cooling capacity in a datacenter (for example, alter distribution of blowers or air conditioning units), identify deficiencies in datacenter infrastructure (for example, identify a need for more power to server racks), alter physical location or layout of server racks in the datacenter, alter airflow in patterns in the datacenter, change temperatures in the datacenter, and/or adjust power knobs, compute knobs, or cooling knows, to name a few examples.

In one exemplary embodiment, temperature data is collected from sensors that are mounted at the inlet and outlet of racks housing stacked electronic or computer equipment, such as servers. By way of example, each rack has ten or more servers vertically stacked with each server including a sensor located at the inlet and a sensor located at the outlet. In a datacenter with one thousand racks, ten thousand or more sensors are used to gather and provide data. Data can be collected continuously or periodically (for example, collected every five to ten seconds from each sensor).

The collected data is analyzed using various exploratory data analysis techniques to identify underlying structure in time and space. Knowing where the data is collected (i.e., the location of the sensors in the datacenter) and when the data is collected (i.e., a time of day, week, month, season, etc.) enable exemplary embodiments to analyze the data with respect to the existing, real-time infrastructure of the datacenter. During the analysis, temperature sensor data obtained from the inlet of racks is normalized and compared with a standard normal distribution to capture the randomness, asymmetry and spread.

Variations in temperature can arise due to uncertainties in the sensing infrastructure (i.e. sensor, transducer, communication) or random and systemic changes in the environment. Calculating the cumulative distribution function temperature data resolves the random variations from the systemic variations. Systemic variations can arise due to periodic or non-periodic changes. One embodiment identifies such variations during runtime to provision cooling at locations within the datacenter.

Analyzing time series data like involves correlating data from identical sources at different points of time to discover repetitive patterns. This technique is called autocorrelation and is applied to temperature trends discovered in the datacenter. Correlation of time-shifted data also helps in identifying appropriate time series models for optimization of control system performance. For instance, such correlations assist in selecting constants to define the control function. Autocorrelations are similar to discrete convolution transforms which can be calculated on real time data to identify data traits and conduct test of significance in real time.

Analysis of the data reveals relationships in space and time among sensors and deployed hardware in the datacenter. Identification of patterns provides insight into datacenter dynamics and is applied to future forecasting purposes. Knowledge of such metrics enables energy-efficient thermal management by helping to create strategies for normal operation and disaster recovery.

In one embodiment, the analysis of the data is used in context of establishing a correlation between computer room air conditioning (CRAC) unit air supply temperatures (cause) and rack inlet temperatures (effect). Sensors respond to air stream temperatures. Air temperatures within datacenter depend on a multitude of factors. By way of example, such factors include the CRAC unit supply air temperatures and the mixing levels of hot exhaust and cold air streams within the datacenter. Based on location of the sensor and the mode of air delivery, CRAC units can have different levels of influence over the sensors. Plenum and rack layout also have significant effect on such influences. Such effects can be quantified by calculating cross correlation coefficients between the sensor and the CRAC air supply temperature.

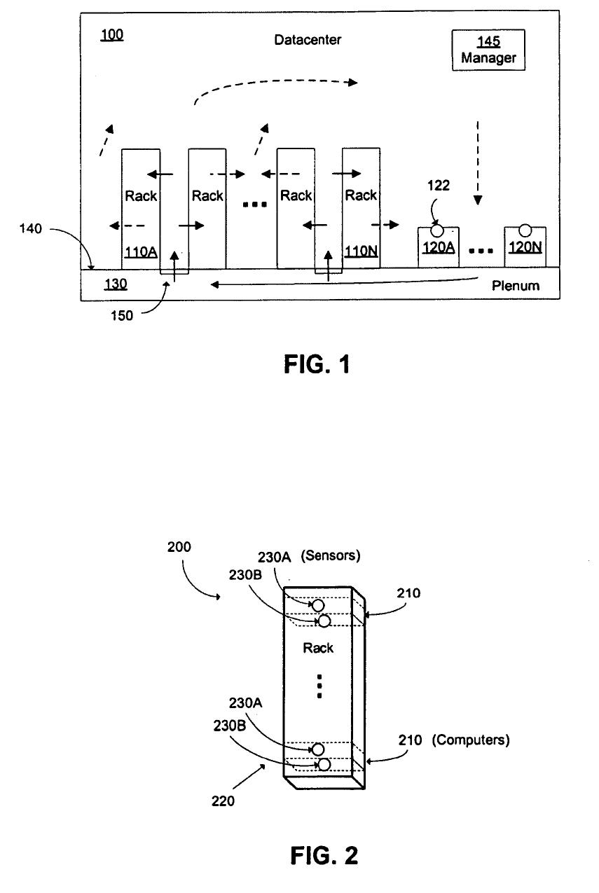

FIG. 1 shows a datacenter 100 in accordance with an exemplary embodiment. The datacenter 100 includes a plurality of computer racks 110A to 110N and a plurality of cooling units 120A to 120N. A plenum or ventilation system 130 is provided under a raised floor 140. The plenum and cooling units provide an air-conditioning environment with under-floor cool air distribution to the computer racks.

The datacenter 100 includes a manager or computer 145 for executing exemplary embodiments in accordance with the present invention. In one embodiment, the manager 145 is located in the datacenter. In an alternate embodiment, the manager is physically located away from the datacenter and coupled to it through one or more networks.

In one embodiment, the cooling units 120 include computer room air conditioning (CRAC) units that cool hot air exhausted from the computer racks 110. Each unit includes one or more sensors, indicated at 122. The sensors collected data, such as outgoing or supply air temperature.

Energy consumption in data center cooling comprises work done to distribute the cool air and to extract heated air from the hot exhaust air. A refrigerated or chilled water cooling coil in the CRAC unit extracts the heat from the air and cools it (for example, cooling the air within a range of 10° C. to 18° C.). The flow of chilled water is controlled by an internal mixing valve that operates based on the air temperature measured at the return of the CRAC unit. In addition to the chilled water CRAC units, a variety of other choices exist in terms of air conditioning equipment selection. By way of example, the data center can have one or more of vapor compression, refrigerant, based air conditioning units, etc.

FIG. 1 shows distribution of cold air (shown with solid lines) and hot air (shown with dashed lines) through the datacenter 100. Air movers in the cooling or CRAC units 120 pressurize the plenum 130 with cool air that circulates through the datacenter. By way of example, the cool air enters the data center 100 through vented tiles 150 located on the raised floor 140 close to the inlet of the computer racks 110. Typically the computer racks 110 are arranged in rows separated with hot air isles and cold air isles. The cold air aisles supply cold air to the systems and the hot air aisles receives hot air from the systems. A multitude of other equipment layout configurations and non-raised floor infrastructures exist and are applicable to exemplary embodiments.

FIG. 2 shows an exemplary computer rack 200 having a plurality of stacked electronic devices, such as computers or servers 210 (shown with dashed lines). An environmental sensing system 220 is used to sense one or more environmental conditions in the computer rack. By way of example, this sensing system 220 includes multiple rack inlet sensors 230A located at a front of the computer rack 200 and multiple rack outlet sensors 230B located at a rear of the computer rack 200. In one exemplary embodiment, each server 210 includes two sensors 230A, 230B. The inlet sensor 230A is located at a front of the server, and the outlet sensor 230B is located at an oppositely disposed rear of the server. The inlet sensor 230A measures temperature of cooler air entering the server, and the outlet sensor 230B measures temperature of warmer air exiting the server.

One exemplary embodiment is discussed in connection with rack-level temperature data collected over a period of several months from a production datacenter. Datacenters experience surges in power consumption due to rise and fall in compute demand. These surges can be long term, short term, or periodic and lead to associated thermal management challenges. Some variations can also be machine-dependent and vary across the datacenter. Yet other thermal perturbations can be localized and momentary. Random variations due to sensor response and calibration, if not identified, can lead to erroneous conclusions and expensive faults.

Exemplary embodiments thus provide techniques to reveal relationships among sensors and deployed hardware in space and time. Exemplary embodiments also identify patterns that provide significant insight into data center dynamics for future forecasting purposes. Knowledge of such metrics enables energy-efficient thermal management by helping to create strategies for normal operation and disaster recovery for use with techniques like dynamic smart cooling.

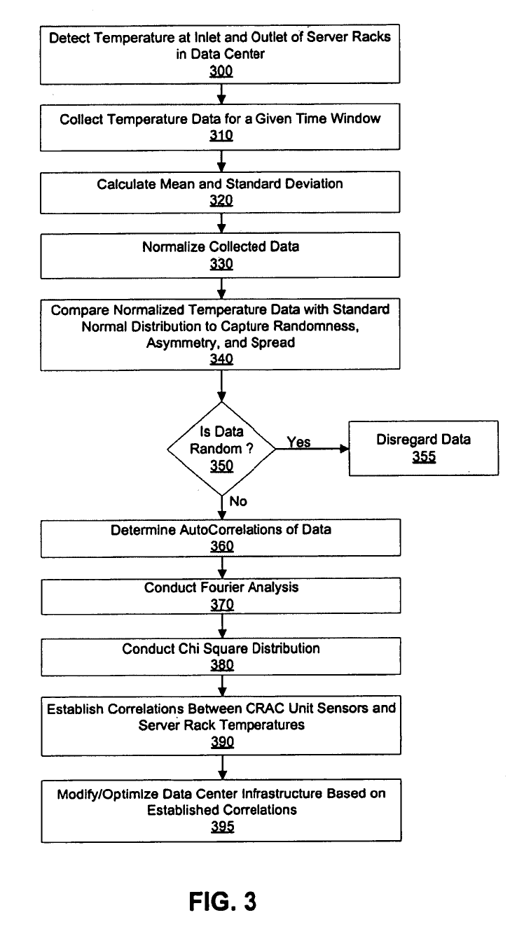

Environmental data collected from sensors mounted at the inlet and outlet of racks is collected and analyzed using various exploratory data analysis techniques to identify underlying structure in time and space. FIG. 3 is a flow diagram for collecting and analyzing data in a datacenter in accordance with an exemplary embodiment. In order to facilitate this discussion, the following nomenclature is used:

T: Temperature,

Ti: Temperature of i^{th} sensor from bottom of rack,

T̅: Average temperature,

[symbol] : Norimalized temperature,

χ²: Chi-square random variable,

ρ_{x,x}: Auto-Correlation Coefficient,

ρ_{x,y}: Cross-Correlation Coefficient,

σ: Standard deviation,

Subscripts

i: Time index,

k: Time shift index

n: Sample size,

Superscripts

j: Sensor index.

According to block 300, temperature is detected at the inlet and outlet of server racks in a datacenter. As one example, sensors are mounted at the inlet and exhaust of the server rack. In this manner, environmental data is collected for each individual server.

According to block 310, temperatures data is collected for given period or window of time. Environmental data can be continuously collected at each of the servers or periodically collected (for example, temperature data sensed at regular interviews, such as once every second, every five seconds, etc.). In one embodiment, environmental data is collected for an entire lifetime of the datacenter.

Temperatures collected during a period of time (for example, a month or longer) can exhibit trends. For example in one exemplary implementation, five temperature sensors were located, equally-spaced, at the front door of the rack starting at 460 mm (1.5 ft) from the bottom of the rack. Daily variations in inlet temperatures were recorded. These variations correlated with weekdays and weekends, with weekdays characterized by temperature surges. Such surges are the indirect effect of increase in compute workload and server utilization.

According to block 320, a mean and standard deviation are calculated for the environmental data collected for the window of time. According to block 330, the data is normalized. Then, according to block 340, the normalized temperature data is compared with the standard normal distribution to capture randomness, asymmetry, and spread.

Temperature sensor data obtained from the inlet of racks is normalized and compared with a standard normal distribution to capture the randomness, asymmetry and spread. Temperature data is normalized using the following equation:

[symbol]

=(T−μ)/σ.

In this equation, μ and σ are mean and standard deviation of the data set. The cumulative frequency distribution of the normalized temperature [symbol] is calculated and plotted in a scatter plot. For comparison purposes, it is compared with the cumulative density function of a standard normal variable. The cumulative density function of the standard normal variable is plotted as a continuous line. A deviation at the median of the distribution indicates a systemic shift in values from random behavior. This is an outcome of the periodic (diurnal) fluctuations in the data set.

Variations in temperature can arise due to uncertainties in the sensing infrastructure (i.e. sensor, transducer, communication) or random and systemic changes in the environment. Calculating the cumulative distribution function temperature data resolves the random variations from the systemic variations. Systemic variations can arise due to periodic or non-periodic changes. In one embodiment, fluctuations are identified during runtime to provision cooling at locations within the datacenter.

Similar tests can be done using other distributions as well. For example, the chi-square distribution with a single degree of freedom is given by the following equation:

χ²≈ [symbol] ².

F-distributions can be used to compare variances among different datasets to understand the impact of infrastructure changes or workload profiles. Lag plots can provide a quick look at the nature of the data without complex analysis. Such an approach not only maximizes insight into a data set and detects outliers and anomalies without assuming any particular model.

According to block 350, a question is asked whether the data is random. If the answer to this question is “yes” then flow proceeds to block 355 and the random data is disregarded. If the answer to this question is “no” then flow proceeds to block 360 wherein an autocorrelation of the data is determined.

Analyzing time series data involves correlating data from identical sources at different points of time to discover repetitive patterns. This technique is called autocorrelation. Correlation of time-shifted data also helps in identifying appropriate time series model for optimization of control system performance. Such correlations can assist in selection of constants to define the control function.

Autocorrelation coefficient for temperature trend is given by the following equation:

$${ρ}_{α}^{j} = \frac{{\sum }_{i}^{n - k} ( {T}_{i + k}^{j} - \overline{T} ) ( {T}_{i}^{j} - \overline{T} )}{{\sum }_{i}^{n} {( {T}_{i}^{j} - \overline{T} )}^{2}} .$$

In this equation, k is the time shift, j is the sensor index, i is the time index and n is the total number of temperature samples. In one embodiment, an optimized selection of time shift and period provides an accurate estimation of the frequency of variations. Autocorrelations can be similar to discrete convolution transforms that are calculated on real time data to identify data traits and conduct tests of significance in real time.

According to block 370, a Fourier analysis is conducted. Then, according to block 380, a Chi-Square distribution is conducted. The Chi-square test is conducted to identify degrees of freedom in the data obtained from the infrastructure. The Fourier analysis is conducted to identify periodic behavior in the data.

Fourier analysis of time series data is a technique for identifying dominant patterns within seemingly complicated temperature fluctuations. By way of example, temperature data is transformed into a spectrum of its frequency components. Fast Fourier algorithm is then used to perform discrete Fourier transform on the temperature data. The discrete Fourier transform is shown in the following equation:

$${T}_{k} = {\sum }_{m = 0}^{n - 1} {T}_{m} {e}^{- \frac{2 πi}{n} mk}$$

$$where$$

$$m = 0 , … , n - 1.$$

In this equation, n is the total number of temperature readings. A spectral plot of the Fourier transform (Tₖ) can be performed. A diurnal peak in temperature response indicates periodicity of workload surge on the server. These responses can be used as signatures for difference workloads for inference purposes. Knowledge of such response characteristics can improve stability of any deployed closed-loop cooling system. Further, understanding data patterns not only allows extraction of important variables like frequency and amplitude of fluctuations but also tests underlying assumptions.

According to block 390, correlations between CRAC unit sensors and server rack temperatures are established. This correlation enables system identification. By way of example, the term “system identification” is used in context of establishing the correlation between CRAC unit air supply temperatures (cause) and rack inlet temperatures (effect). Sensors respond to air stream temperatures. Air temperatures within datacenter depend on a multitude of factors. Such factors include the CRAC unit supply air temperatures and the mixing levels of hot exhaust and cold air streams within the datacenter. Based on location of the sensor and the mode of air delivery, CRAC units may have different levels of influence over the sensors. Plenum and rack layout also have effect on such influences. Such effects can be quantified by calculating cross correlation coefficients between the sensor and the CRAC air supply temperature. The correlation between two parameters is calculated as shown in the following equation:

$${ρ}_{x , y} = \frac{\sum ( {T}_{x} - {\overline{T}}_{x} ) ( {T}_{y} - {\overline{T}}_{y} )}{\sqrt{\sum {( {T}_{x} - {\overline{T}}_{x} )}^{2} \sum {( {T}_{y} - {\overline{T}}_{y} )}^{2}}} .$$

In this equation, the subscripts x and y indicate temperature from non-identical sources, namely rack inlet sensor and CRAC unit air supply sensor.

According to block 395, the datacenter infrastructure is optimized or modified based on the established correlations. In one embodiment, data is collected for real-time management of the datacenter. Changes to the infrastructure of the datacenter are implemented while the datacenter is operating. Since environmental data is acquired and analyzed throughout the lifetime of the datacenter, changes and modifications to the datacenter continue as new data is acquired and assessed.

In one embodiment, correlations are used to understand the current system relationship within the datacenter. These relationships can evolve with changes in infrastructure, workload deployment, or fan speed, to name a few examples. By way of further example, modifications include, but are not limited to moving physical locations of racks and/or servers in the datacenter and changing power, cooling, workload, etc. in order to increase cooling or workload efficiency. With increase in use of variable frequency drives, exemplary embodiments offer an understanding of effects on pressure distribution within the plenum and the overall impact on thermal management at specific locations within the datacenter.

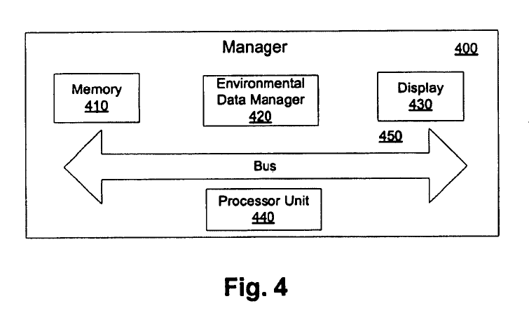

FIG. 4 is a block diagram of a computer or manager 400 in accordance with an exemplary embodiment of the present invention. In one embodiment, the manager or computer includes memory 410, environmental data manager 420, display 430 (optional), processing unit 440 and one or more buses 450.

In one embodiment, the processor unit includes a processor (such as a central processing unit, CPU, microprocessor, application-specific integrated circuit (ASIC), etc.) for controlling the overall operation of memory 410 (such as random access memory (RAM) for temporary data storage, read only memory (ROM) for permanent data storage, and firmware). The processing unit 440 communicates with memory 410 and environmental data manager 420 via one or more buses 450 and performs operations and tasks necessary to collect and analyze environmental data from sensors in the datacenter. The memory 410, for example, stores applications, data, programs, algorithms (including software to implement or assist in implementing embodiments in accordance with the present invention) and other data.

The manager 400 (see also FIG. 1 at 145) is coupled to or in communication with computers and other electronic devices (for example, servers, cooling units, storage devices, etc.) located in the datacenter. The manager receives environmental data from the sensors in the datacenter, analyzes the data, determines patterns in the data, and provides optimizations and/or modifications to the datacenter to improve efficiency, such as workload efficiency, cooling efficiency, etc.

With the development of complex IT and facility infrastructure, rising energy costs and evolving data center service scenarios, exemplary embodiments provide a method and apparatus to manage the life cycle of the data center services. Exemplary embodiments utilize real time management that includes collecting and analyzing environmental data and performing real time modifications to the datacenter to increase efficiency and performance. Exemplary embodiments also utilize exploratory data analysis of environmental data to gather inferences from past performance, to control the present ensemble, and to predict (or prevent) the occurrence of events that effect performance of the datacenter.

As used herein, the word “pattern” means a reliable sample of traits, acts, tendencies, or other observable or measurable characteristics of an apparatus or process.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
collecting temperature data proximate to equipment racks;
identifying patterns in the temperature data; and
using the patterns to adjust an infrastructure housing the equipment racks in real-time to increase cooling efficiency in the datacenter.

2) The method of claim 1 further comprising, sensing the temperature data proximate to both inlets and outlets of the equipment racks located in a datacenter.

3) The method of claim 1 further comprising, calculating a mean and standard deviation of the temperature data.

4) The method of claim 1 further comprising:
identifying random data in the temperature data;
disregarding the random data from analysis to identify the patterns.

5) The method of claim 1 further comprising, using the patterns to adjust temperature and airflow pathways in a datacenter while the datacenter continues to operate so as to increase cooling efficiency in the datacenter.

6) The method of claim 1 further comprising, using the patterns to change a physical location of server racks in a datacenter to increase cooling efficiency in the datacenter.

7) The method of claim 1 further comprising, using the patterns to predict occurrence of events in the infrastructure.

8) A tangible computer readable medium having instructions for causing a computer to execute a method, comprising:
sensing environmental data proximate to equipment racks;
identifying patterns in the environmental data; and
using the patterns to modify an infrastructure in which the equipment racks are located to improve thermal management in the datacenter.

9) The computer readable medium of claim 8 further comprising, determining if the environmental data has patterns with respect to locations where sensors are placed in a datacenter to sense the environmental data.

10) The computer readable medium of claim 8 further comprising, determining if the environmental data has patterns with respect to a time when the environmental data is sensed.

11) The computer readable medium of claim 8 further comprising, using the patterns to modify a cooling capacity of the infrastructure by adding or removing cooling units.

12) The computer readable medium of claim 8 further comprising, using the patterns to modify a physical location of servers in a datacenter to improve cooling efficiency in the datacenter.

13) The computer readable medium of claim 8 further comprising, using the patterns to alter airflow in the infrastructure to improve cooling efficiency in the infrastructure.

14) The computer readable medium of claim 8 further comprising:
normalizing the environmental data;
comparing normalized environmental data with standard normal distribution to capture randomness in the environmental data.

15) The computer readable medium of claim 8 further comprising, conducing Fourier analysis on the environmental data to identify patterns within temperature fluctuations in the environmental data.

16) A system, comprising:
racks including electronic devices;
sensors located on or proximate the racks to sense temperatures proximate to the electronic devices; and
a manager for identifying patterns in the temperatures and automatically modifying an infrastructure to improve thermal management in the infrastructure.

17) The system of claim 16 further comprising, a cooling unit to cool the electronic devices, wherein the manager uses the patterns to determine how to modify fan speed of the cooling unit to improve thermal management in the infrastructure.

18) The system of claim 16, wherein the manager uses the patterns to adjust power settings to servers to improve thermal management in a datacenter.

19) The system of claim 16, further comprising, a cooling unit to cool plural servers, wherein the manager determines a correlation between a temperature sensed by a sensor located proximate to the cooling unit and the sensors located proximate to the racks.

20) The system of claim 16, wherein the manager evaluates data from the sensors and disregards random data included in the data to identify the patterns.
